(19) United States
(12) Patent Application Publication
(10) Pub. No.: US 2015/0018006 A1
(43) Pub. Date: Jan. 15, 2015

(54) METHOD FOR OPERATING A FIELD DEVICE, FIELD DEVICE AND SERVER FOR A WIDE-AREA AUTOMATION NETWORK

(71) Applicant: Phoenix Contact GmbH & Co. KG, Blomberg (DE)

(72) Inventor: Werner Pollmann, Paradiesweg (DE)

(21) Appl. No.: 14/372,721

(22) PCT Filed: Jan. 14, 2013
(86) PCT No.: PCT/EP2013/050545

§ 371 Date: Jul. 16, 2014

(30) Foreign Application Priority Data
Jan. 17, 2012 (DE) 10 2012 100 355.6

(51) Int. Cl. H04W 64/00; H04W 76/02; H04L 12/28; H04W 4/02

(52) U.S. Cl. CPC H04W 64/00; H04W 4/02; H04W 76/021; H04L 12/2854
USPC 455/456.1

(57) ABSTRACT

The invention relates to a method for operating a field device (1) for carrying out measurement and/or automation tasks in a wide-area automation network. The method comprises the steps of detecting the position of the field device (1) in the field device (1), generating a data set identifying the field device (1) and containing the position and a unique identification of the field device (1), transmitting the data set from the field device (1) to a server (10) of the automation network, assigning an identifier to the field device (1) identified by the data set, transmitting the identifier from the server (10) to the field device (1), and communicating in the automation network with use of the identifier. The invention additionally relates to a corresponding field device (1) and a server (10) for carrying out the method.

The present invention relates to a method for operating a field device for carrying out measurement and/or automation tasks in a wide-area automation network. The present invention also comprises such a field device for carrying out measurement and/or automation tasks in a wide-area automation network. In addition, the present invention comprises a server for a wide-area automation network for operating at least one field device for carrying out measurement and/or automation tasks.

Within the scope an increasing centralisation and networking of various functions, automation networks are increasingly being formed that are distributed over a wide area, such that individual field devices of the automation network are sometimes arranged 100 metres or more from one another. The operation of such a wide-area automation network is hindered as a result of the fact that individual components, for example the field devices, are widely distributed, and on-site access is therefore associated with high effort and costs. In addition, such automation networks have been formed in part by amalgamations of existing, sometimes local networks, which occasionally are also to be continued in operation in such a structure, whereby further requirements are placed on the communication within the automation network. Even if individual field devices take on similar tasks in part, it is often necessary to configure these devices specifically, such that they can perform their function. The start-up in the automation network also requires individual configuration. Such automation networks are used for example in conjunction with supply networks, for example for distributing power, gas, water or the like.

Reference will be made hereinafter by way of example to a supply network for power, which comprises such an automation network. Due to the increasing spread of decentrally produced energies, in particular of renewable energies, there are additional requirements in electrical supply networks for the operators of such supply networks in order to operate the supply network efficiently. Such additional requirements arise for example for a local network station, belonging to a local network, within an energy distribution network. Previously, the energy flow usually ran from the power stations via a medium-voltage range and at least one local network station to the local networks, without the occurrence of reverse currents, for example in the medium-voltage range. Due to the increasing spread of decentral energy feeds, for example by block power stations, photovoltaic systems, wind turbines or the like, it is also possible however that energy flows from the local networks into the medium-voltage network and therefore has feedback effects on the operation of the supply network. In order to be able to detect and/or influence these feedback effects, it is necessary to detect and/or to control energy flows in the local network decentrally.

In order to be able to carry out cost-effectively the operation and the start-up of decentral field devices for carrying out measurement and/or automation tasks, for example the detection and/or influencing of energy flows, these procedures are to be carried out easily by service staff, without the need for especially qualified specialist staff. The service staff has knowledge for the installation of field devices, but usually has no or only a little knowledge when dealing with automation components. It is therefore sought in part to configure the field devices prior to the installation, however this is prone to errors. In addition, the integration of the field devices in the systems of the operators of the automation networks is problematic, since these often use dedicated, specially selected identifiers for individual field devices or decentral stations assigned thereto so as to be able to work internally in the usual way. For operation and start-up, specific knowledge of the automation network is therefore also necessary, which the service staff usually does not have. In the case of the supply network, knowledge of the supply network itself may be necessary alternatively or additionally.

In order to facilitate the servicing of field devices in supply networks, a field device with a GPS module, which can forward its position to a control room or a control system, is known from DE 101 63 564 A1. The field device can be easily located by a service technician on the basis of this position.

Proceeding from the above-specified prior art, the object of the invention is therefore to specify a method, a field device and a server of the above-mentioned type, which enable simple operation and simple start-up of a field device in an automation network.

The object is achieved in accordance with the invention by the features of the independent claims. Advantageous embodiments of the invention are specified in the dependent claims.

A method for operating a field device for carrying out measurement and/or automation tasks in an automation network is thus specified in accordance with the invention. The method comprises the steps of detecting the position of the field device in the field device, producing a data set identifying the field device and containing the position and a unique identification of the field device, transmitting the data set from the field device to a server of the automation network, assigning an identifier to the field device identified by the data set, transmitting the identifier from the server to the field device, and communication in the automation network with use of the identifier.

In addition, a field device for carrying out measurement and/or automation tasks in an automation network is specified in accordance with the invention. The field device comprises a position detection unit, which is configured to detect the position of the field device, a processing unit for producing a data set identifying the field device and containing the detected position and a unique identification of the field device, and a communication unit, which is configured to transmit the data set to a server of the automation network and to receive an identifier from the server, wherein the field device is configured to communicate with the automation network with use of the identifier.

Furthermore, a server for an automation network for operating at least one field device for carrying out measurement and/or automation tasks is specified in accordance with the invention. The server comprises a server communication unit and an assignment unit, which is configured to assign an identifier to a field device identified by a data set containing the position and a unique identification, wherein the server communication unit is configured to receive the data set from the field device and to transmit the identifier to the field device, and the server is configured to communicate with the field device with use of the identifier.

The basic concept of the present invention is thus to facilitate the communication with the field device in the automation network by means of a unique assignment of the position and a unique identification of the field device, such that the field device with the identifier assigned by the server can be used for communication. This assignment can be performed at any time, such that it is not necessary to carry out a prior fault-prone assignment. The start-up is facilitated since the assignment is performed automatically. Due to the distances provided in wide-area automation networks between individual decentral stations, for example decentral energy feeds, the unique assignment of the identifier is possible with sufficient accuracy, even though the position can be determined only with a fault tolerance which is usually in the range of less than 100 m, preferably in the range of at most 10 m. The distances between individual decentral stations may typically be approximately 100 metres or more, sometimes also approximately 10 metres or more. The position of the field device is detected as an absolute geographical position. This takes place in the position detection unit and can be carried out arbitrarily. In principle, the position of the field device can be input manually in any format into the field device and provided to the position detection unit. The field device is advantageously configured to automatically initiate the transmission of the data set when first started, such that all further communication can be performed with the identifier. In an alternative embodiment, the field device is configured to transmit the data set by a manipulation, for example by an initialisation button. The unique identification of the field device preferably comprises a serial number of the field device or a component of the field device, a fixed assigned network address, for example a Mac address, a telephone number or the like. The unique identification may also be a unique identification assigned to the field device especially for identification purposes, the identification being assigned by way of example by the manufacturer of the field device. The communication unit and the server communication unit may be configured independently. They can carry out a communication via a wired or wireless network, for example GSM, GPRS, WLAN, Ethernet, Powerline or the like, which are used for communication in the automation network, without being an integral part of the automation network. By way of example, the communication unit and the server communication unit can be configured as network adapters for connection to the network. In particular, the connection between the field device and the server can be produced via an Internet connection. The automation network enables a communication of the field device for example with a control centre, wherein the network may comprise at least one public communication network. The network is preferably part of the automation network so as to enable the communication with the field device. The field device is preferably configured to store the identification. The field device can thus communicate directly with use of this identification in the case of a restart. The identifier may be an arbitrary character combination, for example an alphanumerical name. Here, the term “data set” is to be understood to mean the combination of the position and the unique identification. This is independent of the way in which the position and the unique identification are transmitted from the field device to the server. By way of example, the position and the unique identification can be transmitted from the field device to the server in different data packets and even via different transmission paths. The field device is an otherwise conventional field device for carrying out measurement and/or automation tasks, for example for measuring decentrally produced and fed energy, wherein, in a further embodiment, the feed is controlled alternatively or additionally by the field device. The server preferably provides the identifier to at least one further component of the automation network, for example a control centre, such that communication can take place between the field device and this further component with use of the identifier.

In accordance with a preferred embodiment of the invention, the step of detecting the position of the field device comprises the evaluation of position data, in particular satellite position data. The position data can be any data suitable for determining an absolute geographical position therefrom. The use of satellite position data, for example on the basis of the GPS system, has proven its worth for position determination.

In accordance with a preferred embodiment of the invention, the step of detecting the position of the field device comprises the connection of the field device to a receiver for position data, in particular for satellite position data, the receipt of position data in the receiver, and the transmission of the received position data from the receiver to the field device. Accordingly, the field device furthermore comprises an interface for the connection to a receiver for position data, in particular for satellite position data, wherein the position detection unit is configured to receive position data from the receiver for position data via the interface. For fixedly installed field devices, a one-time detection of the position is often sufficient for operation. Accordingly, it is possible to dispense with the configuration of field devices having complex receiving devices for position data and a complex position detection. The field device can thus be produced cost-effectively and easily.

In accordance with a preferred embodiment of the invention, the field device comprises a receiver for position data, in particular for satellite position data. The corresponding field device is characterised by simple installation, since merely the field device itself has to be connected to the automation network for operation and in particular for start-up.

In both aforementioned cases, the receiver for position data can be configured as a simple receiver that transmits the received position data directly to the position detection unit, or the receiver comprises a processing unit, which processes the position data, and transmits a processing result to the position detection unit. The processing of the position data may include the determination of the position of the field device.

In accordance with a preferred embodiment of the invention, the method comprises the additional steps of comparing the position of the field device identified by the data set with positions of known field devices in the automation network, and of transmitting the identifier of a known field device having the same position to the field device identified by the data set. Accordingly, the server is configured to compare the position of the field device identified by the data set with positions of known field devices in the automation network and to transmit the identifier of a known field device having the same position to the field device identified by the data set. As a result of the comparison of the position of field devices, an exchange of a field device for another can be determined. With the assignment of the identifier, the exchange of the field device can take place transparently, without the need for changes in the communication for operation of the field device. As a result of a comparison of the unique identification, it is additionally possible to check whether it is the field device located at the position that again sends a data set to the server. The server can consult the positions of field devices known to it for the comparison. If a plurality of servers are used in the automation network, the server may additionally consult other servers of known field devices for the comparison. The comparison of the position is preferably carried out under consideration of a tolerance for the position of the field device located within the range of the tolerance for the detection of the position of the field device.

In accordance with a further embodiment of the invention, the method comprises the additional step of transmitting configuration data from the server to the field device in accordance with the position of the field device. Furthermore, the server is accordingly configured to transmit configuration data to the field device under consideration of the position. Accordingly, the field device is also configured to receive configuration data from the server. The configuration data may concern both the operation of the function of the field device, that is to say its measurement function and/or its control function, and the communication via the communication unit. Any other components of the field device may also be configured accordingly. Due to the configuration under consideration of the position of the field device, this field device can be used efficiently in the automation network.

In accordance with a further advantageous embodiment of the invention, the server transmits map information to the field device. The map information is preferably transmitted under consideration of the position of the field device.

In accordance with a preferred embodiment of the invention, the step of assigning an identifier to the field device identified by the data set comprises the generation of a logical name under consideration of the position of the field device. The assignment unit is accordingly configured to assign a logical name to the field device identified by a data set containing the position and a unique identification under consideration of the position of the field device. The assignment of a logical name enables easy integration of the field device into the automation network. A corresponding integration into the supply network is also facilitated. Maintenance work on the field device is facilitated in that the maintenance staff can use the identifier to determine for example the position of the field device.

In accordance with a further advantageous embodiment of the invention, the communication unit is configured to transmit the data set to a server of the automation network under consideration of the position of the field device. By way of example, with the use of a plurality of servers in the automation network, the geographically closest and/or responsible server can thus be selected by the field device, based on position of the field device, in order to initiate a communication therewith.

In accordance with a further embodiment of the invention, the field device is configured, under consideration of its position, to carry out a position-based configuration of the communication unit for communication with the server, in particular to carry out the transmission of the data set and receipt of the identifier. The position-based configuration of the communication unit for example comprises a country-specific configuration, in particular for the establishment of a telecommunications link with accordingly configured communication unit. By way of example, transmission protocols to be used, dial-in nodes, prefixes necessary therefor or the like can be preconfigured in the field device in accordance with the position thereof. A configuration is preferably performed by the server following the position-based configuration by the field device.

The invention will be explained in greater detail hereinafter with reference to the accompanying drawing on the basis of preferred embodiments.

In the drawing:

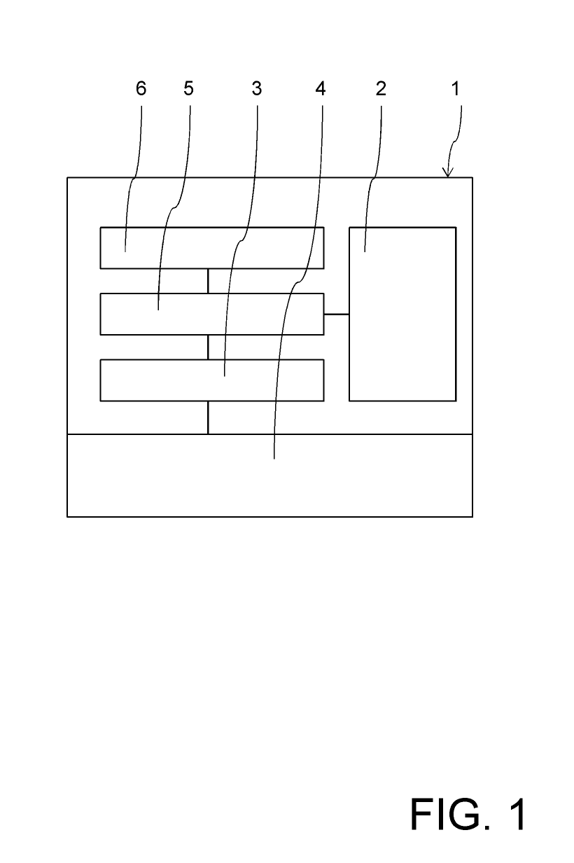

FIG. 1 shows a schematic view of a field device in accordance with an embodiment of the present invention,

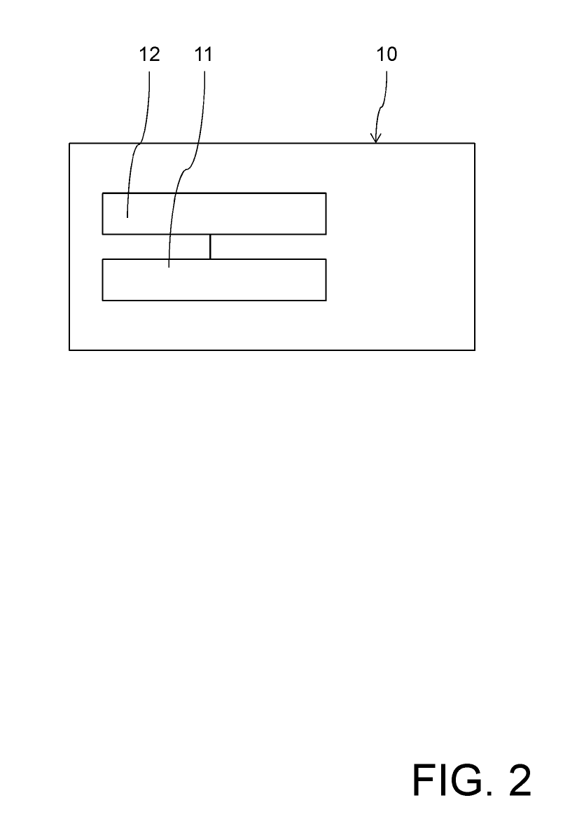

FIG. 2 shows a schematic view of a server of an embodiment of the present invention for communication with the field device from FIG. 1,

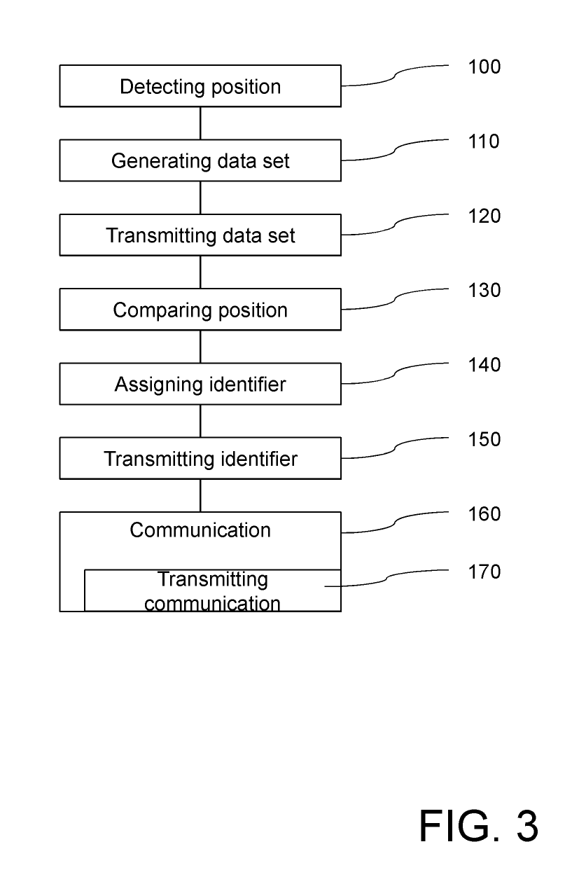

FIG. 3 shows the method for operating the field device from FIG. 1 in an automation network with a server from FIG. 2 in accordance with an embodiment of the present invention, and

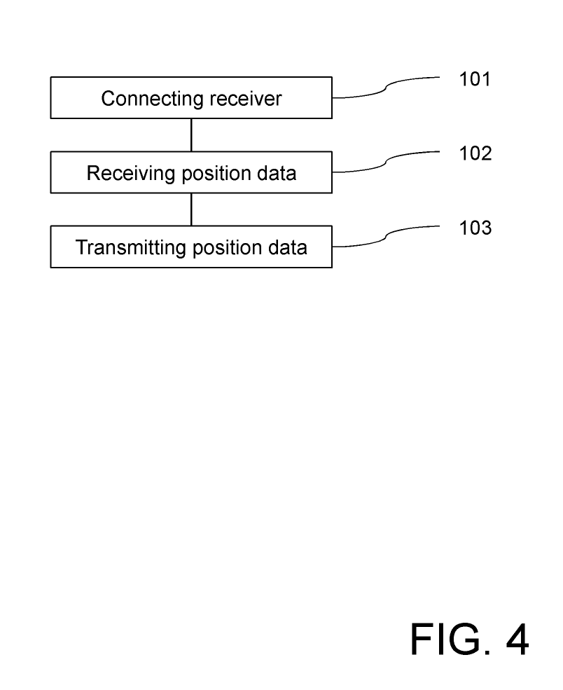

FIG. 4 shows a method for determining the position of the field device in accordance with an alternative embodiment of the present invention.

FIG. 1. shows a field device 1 according to the invention in accordance with a first embodiment of the invention. The field device 1 is configured to carry out measurement and/or automation tasks in a wide-area automation network. Here, the automation network is configured by way of example for communication in accordance with the Ethernet standard and is part of a supply network for the distribution of electrical energy, in which the field devices 1 are located 100 m or more from one another in part. The field device 1 in this exemplary embodiment comprises a measurement unit 2 for measuring a current generated by a decentral energy generation unit, for example a photovoltaic system or a wind turbine, and fed into the supply network. The automation network, the energy generation unit and the supply network are not shown in the figures.

The field device 1 further comprises a position detection unit 3 and a receiver 4 for position data. The receiver 4 is configured in this exemplary embodiment as a GPS receiver for receiving satellite position data. The position detection unit 3 is configured to evaluate satellite position data provided by the receiver 4 for position data and to detect therefrom the position of the field device 1.

In a second embodiment of the invention, the receiver 4 for position data is configured separately from the field device 1. The field device 1 accordingly comprises an interface for the connection to the receiver 4 for position data, and the position detection unit 3 is configured to receive the position data from the receiver 4 for position data via the interface.

The field device 1 further comprises a processing unit 5 and a communication unit 6. The communication unit 6 is configured in this exemplary embodiment as a network adapter in accordance with the Ethernet standard for connection to the automation network and accordingly has a MAC address, which constitutes a unique identification. In an alternative embodiment, the communication unit is configured as a DSL or GSM/GPRS modem for connection to a corresponding network, wherein the communication unit 6 has corresponding unique identifications, for example a telephone number for the establishment of the GSM/GPRS connection via the GSM/GPRS modem. A serial number is additionally stored in the field device 1 and, as a unique identification, identifies the field device 1 and can be read by the processing unit 5. The processing unit 5 is configured to generate a data set identifying the field device 1. The processing unit 5 is configured to generate the data set with the position detected by the position detection unit 3, the serial number of the field device 1 and the MAC address of the communication unit 6. The communication unit 6 is further configured to transmit the data set to a server 10 of the automation network, which is shown in detail in FIG. 2, and to receive messages from the server 10.

The server 10 is configured as a server 10 for the automation network for operating at least one field device 1 for carrying out measurement and/or automation tasks. In accordance with an alternative embodiment, the automation network comprises a plurality of servers 10, which are each formed similarly. The server 10 comprises a server communication unit 11, which is configured to receive the data set identifying the field device 1 from said field device. The server 10 further comprises an assignment unit 12, which is configured to assign an identifier to the field device 1 identified by the data set. The identifier is an alphanumerical character chain in this exemplary embodiment. The server communication unit 11 is further configured to transmit the identifier to the field device 1.

The server 10 is additionally configured to compare the position of the field device 1 identified by the data set with positions of known field devices 1 in the automation network. If the comparison reveals that the field device 1 identified by the data set is positioned at the position of an already known field device 1, this is recognised as an exchange of the corresponding field device 1, and the identifier of the known field device 1 is transmitted to the field device 1 positioned at the same location and identified by the data set.

The field device 1 and server 10 are configured to communicate with one another with use of the identifier assigned to the field device 1.

The server 10 is additionally configured to transmit configuration data to the field device 1 under consideration of its position. The field device 1 is accordingly configured to receive this configuration data from the server 10. The field device 1 performs a configuration on the basis of this configuration data, such that it is integrated automatically into the automation network and the supply network.

The method for operating the field device 1 for carrying out measurement and/or automation tasks in the automation network will be explained further below.

In a first step 100, the position of the field device 1 in the field device 1 is detected. To this end, the satellite position data are transmitted from the receiver 4 for position data to the position detection unit 3, which detects therefrom the position of the field device 1.

In an alternative embodiment, the position is detected in the receiver 4 for position data, and the position is transmitted to the position detection unit 3.

In a step 110, the data set identifying the field device 1 containing the position of the field device 1 and the MAC address of the communication unit 6 and the serial number of the field device 1 is generated in the processing unit 5.

In a step 120, the data set is transmitted from the processing unit 5 to the communication unit 6, which transmits said data set via the automation network to the server 10. Here, the communication unit 6 is configured to transmit the data set under consideration of the position of the field device 1. Accordingly, a server 10 of the automation network is selected, which is located in the geographical vicinity of the field device 1 and is responsible for the position of the field device 1. Furthermore, the field device 1 is configured to carry out a configuration of the communication unit 6 based on the position of the field device 1 prior to the transmission of the data set. The configuration of the communication unit 6 serves to enable the communication with the server 10, for example by performing country-specific adjustments. If the communication unit 6 is a GSM/GPRS modem, corresponding prefixes and a dial-in number are selected for the connection to the automation network.

In step 140, the alphanumerical identifier is assigned, in the assignment unit 12 of the server 10 on the basis of the data set received by the server communication unit 11, to the field device 1 identified by said data set. To this end, the position of the field device 1 is compared with positions of known field devices 1 in the automation network. If a field device 1 is already known in the automation network at the position, the identifier of the known field device 1 is assigned to the field device 1 identified by the data set. Accordingly, the field device 1 having the same position is recognised and treated as an exchange of the previous field device 1. The assignment of the identifier to the field device 1 identified by the data set comprises the generation of a logical name under consideration of the position and/or the function of the field device 1.

In step 150, the identifier is transmitted from the server 10 to the field device 1. To this end, the identifier is transmitted from the assignment unit 12 to the server communication unit 11, which carries out the transmission via the automation network to the communication unit 6 of the field device 1. The identifier is transmitted from the communication unit 6 of the field device 1 to the processing unit 5 and is stored therein.

In step 160, a communication takes place in the automation network with use of the identifier. Here, the field device 1 can communicate with any units in the automation network that are made available by the identifier from the server 10. The server 10 may thus be configured exclusively for the assignment of the identifier and transmission thereof to the field device 1, whereas the other function of the automation network is carried out on at least one further central computer, for example a control centre.

In step 170, configuration data are transmitted, as part of the communication in the automation network, from the server 10 to the field device 1 in accordance with the position of the field device 1 so as to configure this, as described previously. Step 170 is optional.

In accordance with the second above-described embodiment, the step 100 of detection of the position of the field device 1 comprises further individual steps specified below, wherein the rest of the method can be carried out identically.

In step 101, the field device 1 is connected to receivers 4 for position data. The connection is made via the corresponding interface at the field device 1.

In step 102, the receiver 4 receives satellite position data.

In step 103, the satellite position data received by the receiver 4 are transmitted to the field device 1.

### LIST OF REFERENCE SIGNS

1 field device
2 measurement unit
3 position detection unit
4 receiver
5 processing unit
6 communication unit
10 server
11 server communication unit
12 assignment unit

1. A method for operating a field device for carrying out measurement and/or automation tasks in a wide-area automation network, comprising the following steps:
detecting the position of the field device in the field device,
generating a data set identifying the field device and containing the position and a unique identification of the field device,
transmitting the data set from the field device to a server of the automation network,
assigning an identifier to the field device identified by the data set,
transmitting the identifier from the server to the field device, and
communicating in the automation network with use of the identifier.

2. The method according to claim 1, characterised in that the step of detecting the position of the field device comprises the evaluation of position data, in particular of satellite position data.

3. The method according to claim 1, characterised in that
the step of detecting the position of the field device comprises:
connecting the field device to a receiver for position data, in particular for satellite position data,
receiving position data in the receiver, and
transmitting the received position data from the receiver to the field device.

4. The method according to claim 1, comprising the following additional steps:
comparing the position of the field device identified by the data set with positions of known field devices in the automation network, and
transmitting the identifier of a known field device having the same position to the field device identified by the data set.

5. The method according to claim 1, comprising the following additional step:
transmitting configuration data from the server to the field device in accordance with the position of the field device.

6. The method according to claim 1, characterised in that the step of assigning an identifier to the field device identified by the data set comprises the generation of a logical name under consideration of the position of the field device.

7. A field device for carrying out measurement and/or automation tasks in a wide-area automation network, comprising
a position detection unit, which is configured to detect the position of the field device,
a processing unit for generating a data set identifying the field device and containing the detected position and a unique identification of the field device, and
a communication unit, which is configured to transmit the data set to a server of the automation network and to receive an identifier from the server, wherein
the field device is configured to communicate with the automation network with use of the identifier.

8. The field device according to claim 7, characterised in that
the field device comprises a receiver for position data, in particular for satellite position data.

9. The field device according to claim 7, characterised in that
the field device comprises an interface for the connection to a receiver for position data, in particular for satellite position data, wherein the position detection unit is configured to receive position data from the receiver for position data via the interface.

10. The field device according to claim 7, characterised in that
the field device is configured to receive configuration data from the server.

11. The field device according to claim 7, characterised in that
the communication unit is configured to transmit the data set to a server of the automation network under consideration of the position of the field device.

12. The field device according to claim 7, characterised in that
the field device is configured, under consideration of its position, to carry out a position-based configuration of the communication unit for communication with the server, in particular for transmission of the data set and receipt of the identifier.

13. A server for a wide-area automation network for operating at least one field device for carrying out measurement and/or automation tasks, comprising
a server communication unit and
an assignment unit, which is configured to assign an identifier to a field device identified by a data set containing the position and a unique identification,
wherein
the server communication unit is configured to receive the data set from the field device and to transmit the identifier to the field device, and
the server is configured to communicate with the field device with use of the identifier.

14. The server according to claim 13, characterised in that
the server is configured to compare the position of the field device identified by the data set with positions of known field devices in the automation network and to transmit the identifier of a known field device having the same position to the field device identified by the data set.

15. The server according to claim 13, characterised in that
the server is configured to transmit configuration data to the field device under consideration of the position.

16. The method according to claim 2, characterised in that
the step of detecting the position of the field device comprises:
connecting the field device to a receiver for position data, in particular for satellite position data,
receiving position data in the receiver, and
transmitting the received position data from the receiver to the field device.

17. The method according to claim 2, comprising the following additional steps:
comparing the position of the field device identified by the data set with positions of known field devices in the automation network, and
transmitting the identifier of a known field device having the same position to the field device identified by the data set.

18. The method according to claim 16, comprising the following additional steps:
comparing the position of the field device identified by the data set with positions of known field devices in the automation network, and
transmitting the identifier of a known field device having the same position to the field device identified by the data set.

19. The method according to claim 2, comprising the following additional step:
transmitting configuration data from the server to the field device in accordance with the position of the field device.

20. The method according to claim 16, comprising the following additional step:
transmitting configuration data from the server to the field device in accordance with the position of the field device.
